(19) United States
(12) Patent Application Publication
(10) Pub. No.: US 2010/0095599 A1
(43) Pub. Date: Apr. 22, 2010

(54) SEALING SYSTEM FOR VEHICLE DOOR LEAF, METHOD FOR MAKING SAME AND VEHICLE INCLUDING SAME

(76) Inventors: Laurent Coldre, La Neuville sur Essonne (FR); Olivier Laude, Amilly (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/529,250

(22) PCT Filed: Mar. 3, 2008
(86) PCT No.: PCT/FR08/00277

§ 371 Date: Oct. 13, 2009

(30) Foreign Application Priority Data
Mar. 1, 2007 (FR) 07 01495

(51) Int. Cl. B60J 10/04; B60J 10/00; B60J 10/08; B32B 7/10

(52) U.S. Cl. 49/484.1; 156/91

(57) ABSTRACT

The invention relates to a sealing system for a door leaf with mobile glazing in a motor vehicle, to a method for making the sealing system, and to a vehicle including same. The invention relates to sealing systems including sealing profiles of the type including sliding and mobile-glazing sweeping seals, which can be used in any type of motor vehicle. The sealing system (105) of the invention for such a mobile-glazing door leaf (103) includes at least: an external fitting having a sliding seal (106a) with an outer trim (110), and an internal fitting for said door leaf including an inner seal (106b) with an inner trim (109), each of said fittings being formed of a single piece that is at least partially moulded. The sealing system is such that it further comprises two respectively inner and outer sweeping seals for the glazing

The present invention relates to a sealing system for an openable panel for a door with a movable glass for a motor vehicle, a method for making this sealing system and a vehicle of this kind including same. The invention applies to sealing systems comprising sealing strips using channel gaskets (also called “glass run channels”) and wiping gaskets for movable glass which are usable in all types of motor vehicles, such as automobiles, aircraft, railroad vehicles and boats.

As is known, sealing systems for movable glass of the doors of motor vehicles can have decorative internal and external surfaces in the form of internal and external trim which is added to the corresponding sealing strips. In this field of the lateral sealing of a door with a window, the strips used may in particular be channel gaskets and wiping gaskets for the glass (including internal and external wiping gaskets). This means that the manufacturer has to make and fit separately at least the following components to each side door that has a window, of the vehicle, this list not being exhaustive:
the channel gasket, composed of one or more lengths joined together for example by molding, welding or juxtaposition,
the external trim of the channel gasket which, in the most common case of a hidden frame channel, may for example be applied to and anchored to this gasket, as shown in document DE-B-101 47 015,
an internal door frame trim panel,
an external trim for the B pillar of the door (or “center pillar” of the body, meaning the B pillar separating the front and rear doors in the particular case of a vehicle with four side doors),
an internal trim for this B pillar in the case of a hidden B pillar, and
the internal and external wiping gaskets of the glass.

A big problem with sealing systems incorporating all of the above components is that the components must be manufactured independently of each other and with often different technologies, before being assembled separately in a predetermined manner on the vehicle. This necessarily creates very high costs of manufacture, logistics and assembly due particularly to the high number of parts to be manufactured and assembled, different suppliers and different technologies used for the manufacture of these parts.

Document GB-A-2 312 460 discloses a sealing system for an openable panel for a door with a movable glass comprising an external strip having a channel gasket provided with external trim, and an internal strip incorporating an internal gasket provided with internal trim, each of these strips being one-piece components and partly molded. It will be seen however that in that document, neither the internal nor the external glass wiping gaskets is included in the corresponding internal and external strips.

It is an object of the present invention to provide a sealing system for an openable panel of a door having a movable glass for a motor vehicle which solves these problems, this system comprising as a minimum:
an external strip comprising a channel gasket provided with external trim, and
an internal strip for said openable panel incorporating an internal gasket provided with internal trim,
   each of said strips being formed as a one-piece component which is at least partly molded.

To this end a sealing system according to the invention is such that it also comprises two wiping gaskets respectively internal and external for the glass which are included in said internal strip and external strip, respectively.

The terms “external strip” and “internal strip” refer in the present description, as in the prior art, to the external and internal parts, respectively, of a sealing system or weather stripping performing both sealing and esthetic (i.e. decorative) functions.

It will be observed that a sealing system according to the invention advantageously combines, into a single one-piece component, the channel, the internal or external wiping gaskets and the associated trims, thereby forming a single integral component for each internal and external strip, by injecting molding or overmolding, as will be explained later.

It will also be observed that a sealing system according to the invention can be fitted equally well to a frame of the openable panel of a door as, in the case of an openable panel that has no frame for the movable glass, directly to the vehicle body (and in the latter case, where the external trim is fixed to the body, it is known as a “gutter” or dual on-body seal).

A sealing system according to the invention can thus incorporate in one component, on the outside and inside of the openable panel of the vehicle, not only the channels and associated trim pieces, but also the corresponding external and internal wiping gaskets with the esthetic functions associated with said trim pieces.

In a first embodiment of the invention, at least one of said external and internal trim pieces may be formed in one piece with the rest of the corresponding strip via an adhesive interface (i.e. an interface which produces attachment by adhesive contact due to the molding of the sealing and esthetic parts of the strip).

In this first embodiment, the external strip and/or the internal strip may thus advantageously consist of a mono-injection or bi-injection molded component.

In a second embodiment of the invention, at least one of said external and internal trim pieces is formed in one piece with the rest of the corresponding strip via a mechanical fastening produced by overmolding an insert forming this gasket with an injection-molded material forming the trim.

Another feature of the invention concerning specifically the sealing systems that comprise hidden frame channels and which are designed for an openable panel with no door frame for said glass, is that the sealing system according to the invention is able to perform sealing and decorative functions, both:
on the outside of the vehicle, where this system comprises, for the external strip, an external half-channel gasket which is suitable for mounting on said door frame and with which said external trim is formed integrally by molding, and
on the inside of the vehicle, where this system comprises, for the internal strip, said internal trim which is also suitable for mounting on said door frame and which comprises an internal half-channel gasket formed integrally, by molding, with said internal trim.

In a first example of an embodiment of the invention, said sealing system may thus be able to be fitted to a visible B pillar of the vehicle (in the particular case of a vehicle with four side doors), in a hidden frame channel.

In accordance with this first example, said internal trim may advantageously be approximately U-sectioned, with one arm extended by said internal half-channel gasket which forms a sealing lip designed to press elastically against an internal face of said glass.

Also in accordance with this first example, said external trim may advantageously continue approximately at right angle from said external half-channel gasket in the manner of the top of a “π” whose two legs are designed to grip an axial stub of said frame, and this external trim may be provided with a sealing lip which continues this top of the “π” and is designed to press elastically against an external face of said glass.

In a second example of an embodiment of the invention, said sealing system may thus be able to be fitted to a non-visible B pillar of the vehicle (still referring to a vehicle with four side doors), in a hidden frame channel.

In accordance with this second example, said internal trim may advantageously be approximately U-sectioned, with a first arm extended by said internal half-channel gasket which forms a sealing lip designed to press elastically against an internal face of said glass, and with the second arm continued approximately at right angles away from the first arm by a fixing portion designed to be attached, for example via an adhesive, to a reinforcing bar of said frame.

Also in accordance with this second example, the external trim may advantageously continue approximately at right angle, in the manner of the main leg of a “λ”, from said external half-channel gasket, and said external trim may be provided with at least one sealing lip which continues the base of this leg approximately in the same direction and is designed to press elastically against an external face of the glass.

Another feature of this second example of the invention is that the other base of the “λ” forming said external half-channel gasket may also be provided with a sealing lip designed to press elastically against the internal face of the glass.

Another feature of this second example of the invention is that the main leg of the “λ” formed by said external trim may be provided on its axially internal face with means for attaching this external trim to said frame reinforcing bar, by for example mechanical fastening such as clips and/or adhesive.

A method according to the invention for making a sealing system as defined above is such that it comprises:
injection molding, by for example mono-injection or bi-injection molding, one or both of said external strip and said internal strip for the attachment via an adhesive interface of said corresponding trim to the rest of the corresponding strip, or
overmolding an insert forming the or each gasket with an injected material forming the corresponding trim for the attachment via mechanical fastening of said or each trim to the corresponding gasket,
   which external strip and internal strip include an external wiping gasket and an internal wiping gasket, respectively, for the glass and are each formed in one piece.

Materials that can be used to make the internal and/or external trims of said sealing system include:
preferably thermoplastic materials, for example those based on: polymethyl methacrylate (PMMA); a polyamide (PA); an acrylonitrile butadiene styrene (ABS) resin; polycarbonate (PC); or an acrylate styrene acrylonitrile resin (known as “ASA” and obtained by introducing an acrylate-based elastomer during copolymerization of styrene and acrylonitrile); polybutylene terephthalates (PBT); polyethylene terephthalates (PET); their blends; or
thermosetting materials.

Materials that can be used to make the channel gaskets and/or wiping gaskets of said sealing system include:
preferably thermoplastic elastomers (TPE) such as thermoplastic vulcanizates (TPV), such as “Vegaprene” or “Santoprene”, or
rubber-based materials such as ethylene-propylene diene terpolymers (EPDM).

A motor vehicle according to the invention is of the type comprising a body and at least one openable panel for a door that incorporates a movable glass, such as a glass for a front or rear side door of a motor vehicle, and which is provided with a sealing system fitted to said or each openable panel or to said body, and this vehicle is such that this sealing system is as defined above in relation to the present invention.

Other features, advantages and details of the present invention will be found on reading the following description of a number of illustrative embodiments of the invention, given by way of non-restrictive illustration, said description being given with reference to the attached drawings, in which:

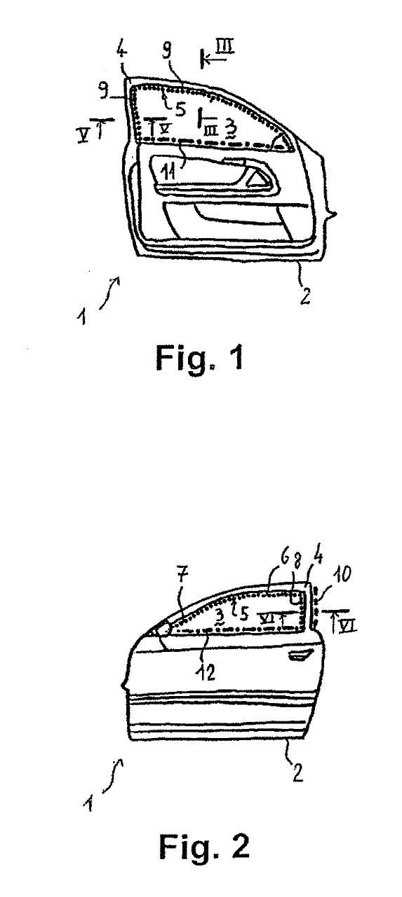

FIG. 1 is a diagrammatic elevation of the internal face of an openable panel of a side door of an automobile incorporating a sealing system according to the invention around the perimeter of the glass of the openable panel,

FIG. 2 is a diagrammatic elevation of the external face of the openable panel of FIG. 1 incorporating this sealing system,

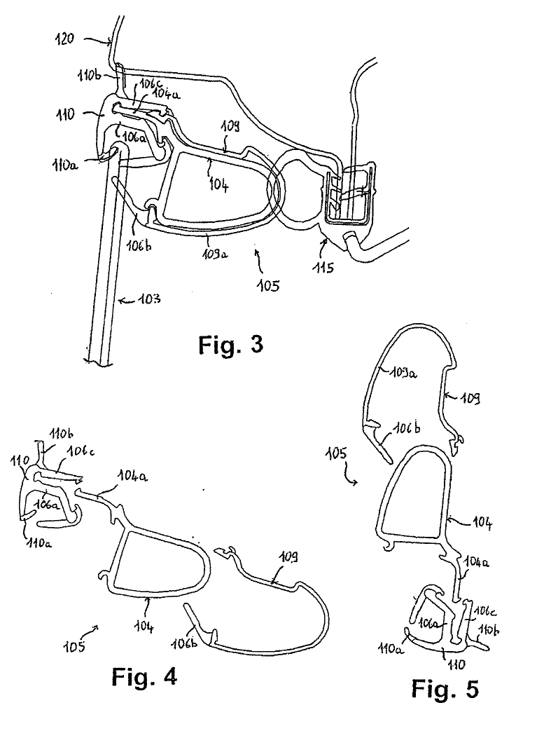

FIG. 3 is an assembly view in cross section on the plane marked in FIG. 1 of a first illustrative embodiment according to the invention of this sealing system, relating to a hidden frame channel with the B pillar of the vehicle visible,

FIG. 4 is an exploded cross section through the sealing system shown by way of example in FIG. 3,

FIG. 5 is an exploded cross section on the plane marked V-V in FIG. 1 of the sealing system in this first example shown in FIGS. 3 and 4,

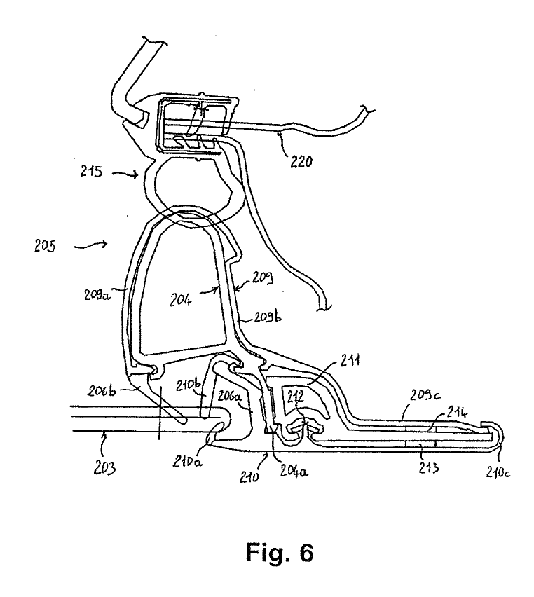

FIG. 6 is an assembly view in cross section on the plane marked VI-VI in FIG. 2 of a second illustrative embodiment of a sealing system according to the invention, relating to a hidden frame channel with the B pillar of the vehicle not visible, and

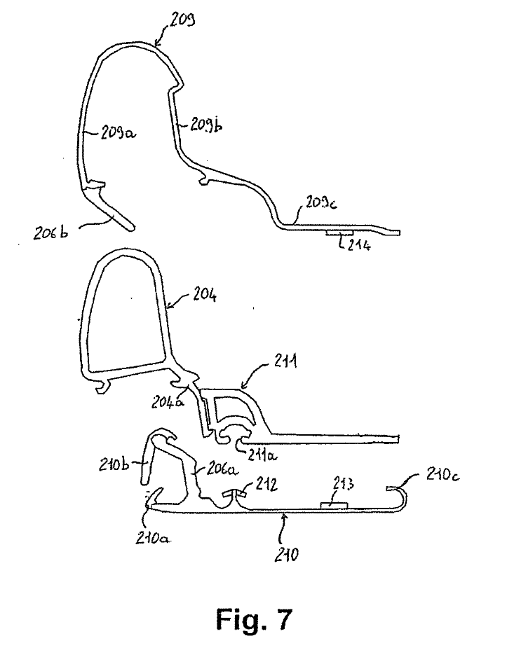

FIG. 7 is an exploded cross section through the sealing system of the example shown in FIG. 6.

Hereinafter, the expressions “axially inward” and “axially outward” will be used to denote the position of a component of each sealing system towards the interior and towards the exterior, respectively, in the direction of the Y-axis, that is the width, of the vehicle.

The openable panel of the side door 1 shown in FIGS. 1 and 2 for a motor vehicle, such as an automobile, essentially comprises a door 2 in the top of which is a roll-down glass 3 which is mounted, in this example, in a door frame 4. This openable panel 1 incorporates a sealing system 5 according to the invention around the perimeter of the frame 4, this system 5 comprising among other things:
a channel gasket 6 (shown in dots in FIG. 2) comprising an upper length 7 and a vertical length 8 and external trim for this channel gasket 6 (not visible),
an internal edging and an internal trim 9 for the frame 4 (shown in dots in FIG. 1),
an external trim 10 for the vertical frame or B pillar (shown as dashes in FIG. 2), in the case of a vehicle with four openable side panels 1, and
the internal wiper gasket 11 and external wiper gasket 12 of the glass 3 (shown in chain lines in FIGS. 1 and 2, respectively).

The sealing system 105 shown in exploded view in FIGS. 4 and 5 and in assembled view in FIG. 3 corresponds to a first illustrative embodiment of the invention, which relates to a hidden frame channel with a visible B pillar and which illustrates both the internal and external parts according to the invention —both of them one-piece molded components—of this sealing system 105. As shown in FIG. 3, this sealing system 105 is designed to cooperate with an upper gasket 115 of the vehicle body 120 when the openable door panel 1 is shut.

The cutting plane III-III selected for FIGS. 3 and 4 corresponds to a cross section taken transversely in the upper region of the sealing system 5 shown in each of FIGS. 1 and 2, while the cutting plane V-V selected for FIG. 5 corresponds to a cross section taken transversely in the vertical region of this same sealing system 5.

As shown in these FIGS. 3-5, the sealing system 105 is able to perform both sealing and decorative functions:
on the outside of the vehicle, where this system 105 comprises, as an external strip, an external half-channel gasket 106a designed to be mounted on the door frame 104, with which external trim 110 is formed integrally by molding, and
on the inside of the vehicle, where this system 105 comprises, as an internal strip, internal trim 109 which is also designed to be mounted on the frame 104 and comprises a lower half-channel gasket 106b formed integrally, by molding, with the internal trim 109.

More specifically, the external trim 110 continues approximately at right angles to the external half-channel gasket 106a in the manner of the top of a “π”, the two legs 106a and 106c of which are designed to grip an axial stub 104a of the frame 104, and this external trim 110 is provided with two sealing lips 110a and 110b attached to the two respective ends of the top of the “it” and which are designed to press elastically against the external face of the glass 103 and against the vehicle body 120, respectively, in the aforementioned upper region of the sealing system 105 (see FIG. 3).

The internal trim 109 is approximately U-sectioned with one arm 109a extended by the internal half-channel gasket 106b which forms a sealing lip designed to press elastically against the internal face of the glass 103 (see FIG. 3).

The sealing system 205 shown in exploded view in FIG. 7 and in assembled view in FIG. 6 corresponds to a second illustrative embodiment of the invention, which relates to a hidden frame channel with a non-visible B pillar and which illustrates both the internal and external parts according to the invention —both of them one-piece molded components—of this sealing system 205. As shown in FIG. 6, this sealing system is designed to cooperate with an upper gasket 215 of the vehicle body 220 when the openable door panel 1 is shut.

The cutting plane VI-VI selected for FIGS. 6 and 7 corresponds to a cross section taken transversely in the vertical region of the sealing system 5 shown in each of FIGS. 1 and 2.

As shown in FIGS. 6 and 7, the sealing system 205 is able to perform both sealing and decorative functions:
on the outside of the vehicle, where this system 205 comprises, as an external strip, an external half-channel gasket 206a designed to be mounted on the door frame 204, with which external trim 210 is formed integrally by molding, and
on the inside of the vehicle, where this system 205 comprises, as an internal strip, internal trim 209 which is also designed to be mounted on the frame 204 and comprises a lower half-channel gasket 206b formed integrally, by molding, with the internal trim 209.

More precisely, the external trim 210 extends approximately at right angle, in the manner of the main leg of a “λ”, the external half-channel gasket 206a, and this external trim 210 is provided with a sealing lip 210a which continues from the base of this leg in approximately the same direction to press elastically against an external face of the glass 203. The other base of the “λ” forming this external half-channel gasket 206a and extending axially towards the interior is also provided with a sealing lip 210b designed to press elastically against the internal face of the glass 203.

Further, the main leg of the “λ” formed by the external trim 210 is provided on its internal face with means for attaching this trim 210 to a bar 211 which reinforces the frame 204, which reinforcing bar 211 is attached to this frame 204 by for example fixing it mechanically to an axial stub 204a of the frame 204. These means for attaching the external trim 210 to the reinforcing bar 211 comprise, in the illustrative embodiment shown in FIGS. 6 and 7, a mechanical fastening means 212, such as a clip in a corresponding cavity 211a formed on the axially external face of the bar 211, combined with adhesive bonding means 213, such as an adhesive tape.

The internal trim 209 is approximately U-sectioned, with a first arm 209a extended by the internal half-channel gasket 206b which forms a sealing lip designed to press elastically against an internal face of the glass 203, and with a second arm 209b extended approximately at right angles away from the first arm 209a by a fixing portion 209c designed to be attached, for example by an adhesive tape 214, to the reinforcing bar 211 of the frame 204.

The external trim 210 also advantageously has an edge 210c which is bent axially inward and extends from the main leg of the “λ”, at the far edge from the sealing lip 210a, and which is designed to grip both the reinforcing bar 211 and the fixing portion 209c of the internal trim 209.

As indicated earlier, the sealing system 105, 205 with molded strips according to the invention can be made by:
injection molding, e.g. mono-injection or bi-injection molding, both the internal strip and the external strip for attachment via an adhesive interface of the corresponding trim 109, 110, 209, 210 to the rest of the corresponding strip, or by
overmolding an insert forming each gasket 106a, 106b, 206a, 206b with an injected material forming the corresponding trim 109, 110, 209, 210, for attachment via mechanical fastening of the latter to the rest of the strip which it decorates.

In this way it will be observed that the sealing system 105, 205 using an external strip and an internal strip both formed as a one-piece component has the following advantages, among others:
fewer steps required to fit the gasket/trim assembly along the top of the door (one to two parts to each of the external and internal sides),
this sealing system is easy to fit,
the external part and internal part of this system can be disconnected, and
the relatively low mass of the system as a whole.

1. A sealing system for an openable panel of a door having a movable glass for a motor vehicle, this system comprising at least:
an external strip comprising a channel gasket provided with external trim, and
an internal strip for the openable panel incorporating an internal gasket provided with internal trim,
each of said strips being formed as a one-piece component which is at least partly molded, the system also comprising two wiping gaskets respectively internal and external for the glass which are included in said internal strip and external strip, respectively.

2. The sealing system as claimed in claim 1, wherein at least one of said external and internal trim pieces is formed in one piece with the rest of the corresponding strip via an adhesive interface.

3. The sealing system as claimed in claim 2, wherein said external strip and/or said internal strip each consist(s) of a mono-injection or bi-injection molded component.

4. The sealing system as claimed in claim 1, wherein at least one of said external and internal trim pieces is formed in one piece with the rest of the corresponding strip via a mechanical fastening produced by overmolding an insert forming this gasket with an injection-molded material forming the trim.

5. The sealing system as claimed in claim 1, said openable panel comprising a door frame to which said glass is fitted, the system being characterized in that it is able to perform sealing and decorative functions for a hidden frame channel, both:
on the outside of the vehicle, where this system comprises, for the external strip, an external half-channel gasket which is suitable for mounting on said door frame and with which said external trim is formed integrally by molding, and
on the inside of the vehicle, where this system comprises, for the internal strip, said internal trim which is also suitable for mounting on said door frame and which comprises an internal half-channel gasket formed integrally, by molding, with said internal trim.

6. The sealing system as claimed in claim 5, wherein it is able to be fitted to a visible B pillar of the vehicle, in a hidden frame channel.

7. The sealing system as claimed in claim 6, wherein said internal trim is approximately U-sectioned, with one arm extended by said internal half-channel gasket which forms a sealing lip designed to press elastically against an internal face of said glass.

8. The sealing system as claimed in claim 6, wherein said external trim continues approximately at right angle from said external half-channel gasket in the manner of the top of a “π” whose two legs are designed to grip an axial stub of said frame, and in that said external trim is provided with a sealing lip which continues this top of the “π” and is designed to press elastically against an external face of said glass (103).

9. The sealing system as claimed in claim 5, wherein it is able to be fitted to a non-visible B pillar of the vehicle, in a hidden frame channel.

10. The sealing system as claimed in claim 9, wherein said internal trim is approximately U-sectioned, with a first arm extended by said internal half-channel gasket which forms a sealing lip designed to press elastically against an internal face of said glass, and with the second arm continues approximately at right angle away from said first arm by a fixing portion designed to be attached, for example via an adhesive, to a reinforcing bar of said frame.

11. The sealing system as claimed in claim 9, wherein said external trim continues approximately at right angle, in the manner of the main leg of a “λ”, from said external half-channel gasket, and said external trim is provided with at least one sealing lip which continues the base of this leg approximately in the same direction and is designed to press elastically against an external face of said glass.

12. The sealing system as claimed in claim 11, wherein the other base of the “λ,” forming said external half-channel gasket is also provided with a sealing lip designed to press elastically against the internal face of said glass.

13. The sealing system as claimed in claims 10, wherein the main leg of the “λ,” formed by said external trim is provided on its axially internal face with means for attaching this external trim to said frame reinforcing bar.

14. A method for making a sealing system as claimed in claim 1 comprising:
injection molding, one or both of said external strip and said internal strip for the attachment via an adhesive interface of said corresponding trim to the rest of the corresponding strip, or
overmolding an insert forming the or each gasket with an injected material forming the corresponding trim for the attachment via mechanical fastening of said or each trim to the corresponding gasket,
which external strip and internal strip include an external wiping gasket and an internal wiping gasket, respectively, for the glass and are each formed in one piece.

15. A motor vehicle comprising a body and at least one openable panel for a door that incorporates a movable glass for a front or rear side door of a motor vehicle, and which is provided with a sealing system fitted to said or each openable panel or to said body, wherein this sealing system is as defined in claim 1.
